(19) United States
(12) Patent Application Publication
(10) Pub. No.: US 2024/0239194 A1
(43) Pub. Date: Jul. 18, 2024

(54) VEHICLE DISPLAY CONTROL DEVICE

(71) Applicant: TOYOTA JIDOSHA KABUSHIKI KAISHA, Toyota-shi (JP)

(72) Inventors: Miki TSUJINO, Nagakute-shi (JP); Sara YAMAFUJI, Miyoshi-shi (JP); Makoto SUZUKI, Seto-shi (JP); Takatoshi HATTORI, Nagoya-shi (JP); Keigo HORI, Toyota-shi (JP); Kazuhisa MURAKAMI, Toyota-shi (JP); Shinji OHBA, Toyota-shi (JP); Tomoki YOSHIMOTO, Okazaki-shi (JP); Rikuto KUBOTA, Toyota-shi (JP); Daisuke FUKUTOMI, Toyota-shi (JP); Kentaro TAKAHASHI, Toyota-shi (JP)

(73) Assignee: TOYOTA JIDOSHA KABUSHIKI KAISHA, Toyota-shi (JP)

(21) Appl. No.: 18/507,371

(22) Filed: Nov. 13, 2023

(30) Foreign Application Priority Data
Jan. 12, 2023 (JP) 2023-003354

(51) Int. Cl. B60K 35/00; B60W 30/12

(52) U.S. Cl. CPC B60K 35/00; B60W 30/12; B60K 2370/152; B60K 2370/172; B60K 2370/176

(57) ABSTRACT

A vehicle display control device includes a detection unit, a reception unit, and a control unit. The detection unit detects lane markings in the target lane in which the vehicle is traveling. The reception unit receives a display mode from a vehicle occupant. The control unit causes the display unit to display, in the received display mode, an execution image indicating whether lane keeping control in which the vehicle travels staying in the target lane, is executed.

### CROSS-REFERENCE TO RELATED APPLICATION

This application claims priority to Japanese Patent Application No. 2023-003354 filed on Jan. 12, 2023 incorporated herein by reference in its entirety.

### BACKGROUND

### 1. Technical Field

The present disclosure relates to a vehicle display control device.

### 2. Description of Related Art

Japanese Unexamined Patent Application Publication No. 2021-109582 (JP 2021-109582 A) discloses a lane change support device. The lane change support device includes an operation unit, a display unit, and a control unit. The control unit is configured to be able to execute lane change support control for controlling a steering angle of a vehicle so as to support the vehicle in changing lanes, and controls an image displayed on the display unit. The control unit displays a first image on the display unit when an operation continuation time is equal to or longer than a first continuation threshold time. Further, the control unit switches the first image to a second image when the operation continuation time is equal to or longer than a second continuation threshold time that is longer than the first continuation threshold time.

The lane change support device described in JP 2021-109582 A does not cause an execution image indicating whether the lane keeping control in which the vehicle travels staying in a target lane is executed, to be displayed in a display mode received from an occupant. There is an issue that it is difficult for the occupant to understand the execution state of the lane keeping control.

### SUMMARY

The present disclosure has been made in consideration of the above facts, and an object of the present disclosure is to provide a vehicle display control device that allows the occupant to easily understand the execution state of the lane keeping control compared to a case where the execution image is not displayed in the display mode received from the occupant.

A vehicle display control device according to a first aspect includes: a detection unit that detects a lane marking in a target lane on which a vehicle is traveling; a reception unit that receives a display mode from an occupant of the vehicle; and a control unit that causes a display unit to display, in the received display mode, an execution image indicating whether lane keeping control in which the vehicle travels staying in the target lane, is executed.

In the vehicle display control device according to the first aspect, the detection unit detects the lane marking in the target lane on which the vehicle is traveling. The reception unit receives the display mode from the occupant of the vehicle. The control unit causes the display unit to display, in the received display mode, the execution image indicating whether the lane keeping control in which the vehicle travels staying in the target lane, is executed. With the vehicle display control device according to the first aspect, the occupant can easily understand the execution state of the lane keeping control compared to a case where the execution image is not displayed in the display mode received from the occupant.

In a vehicle display control device according to a second aspect, in the vehicle display control device according to the first aspect, the control unit causes the execution image to be displayed without a lane marking image representing the lane marking of the target lane being overlapped.

In the vehicle display control device according to the second aspect, the execution image can be easily seen compared to when the execution image is displayed overlapping the lane marking image.

In a vehicle display control device according to a third aspect, in the vehicle display control device according to the second aspect, the control unit causes the execution image to be displayed between a left lane marking image representing a left lane marking of the target lane and a right lane marking image representing a right lane marking of the target lane.

In the vehicle display control device according to the third aspect, it is possible to intuitively recognize that the vehicle is traveling staying in the target lane.

In a vehicle display control device according to a fourth aspect, in the vehicle display control device according to the third aspect, the reception unit receives, from the occupant, one display mode out of a mode in which the execution images are displayed adjacent to the left lane marking image and the right lane marking image, respectively, a mode in which the execution image is displayed in a middle of the left lane marking image and the right lane marking image, a mode in which the execution image is displayed in an entire area between the left lane marking image and the right lane marking image, and a mode in which the execution image is displayed in a portion excluding a vehicle image representing the vehicle from the entire area between the left lane marking image and the right lane marking image.

In the vehicle display control device according to the fourth aspect, the occupant can select a desired display mode from among a plurality of display modes in which the execution image is displayed between the left marking lane image and the right marking lane image.

In a vehicle display control device according to a fifth aspect, in the vehicle display control device according to any one of the first aspect to the fourth aspect, the reception unit receives the display mode from the occupant before the vehicle travels.

In the vehicle display control device according to the fifth aspect, while ensuring the safety of the occupant, the occupant can easily understand the execution state of the lane keeping control compared to a case where the execution image is not displayed in the display mode received from the occupant.

According to the present disclosure, the occupant can easily understand the execution state of the lane keeping control compared to a case where the execution image is not displayed in the display mode received from the occupant.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing an example hardware configuration of a vehicle according to an embodiment;

FIG. 2 is a block diagram showing an example of the configuration of a ROM in the display control device according to the embodiment;

FIG. 3 is a block diagram showing an example of the functional configuration of a CPU in the display control device according to the embodiment;

FIG. 4 is a flowchart showing an example of the flow of vehicle display control processing according to the embodiment; and

FIG. 5 is a schematic diagram illustrating an example of a display mode screen according to the embodiment;

### DETAILED DESCRIPTION OF EMBODIMENTS

A vehicle 12 according to this embodiment will be described below with reference to the drawings.

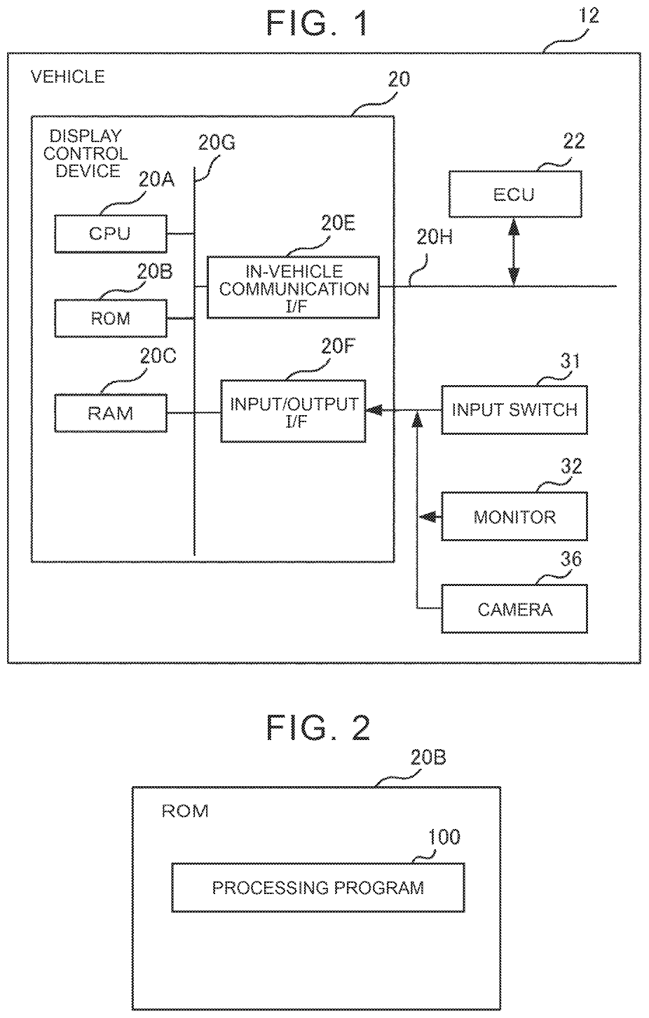

As shown in FIG. 1, the vehicle 12 includes a display control device 20 as a vehicle display control device, an Electronic Control Unit (ECU) 22, an input switch 31, a monitor 32 as a display section, and a camera 36.

Examples of the ECU 22 include a steering ECU that controls power steering, a body ECU that controls each part of the body, and an ADAS-ECU that centrally controls advanced driver-assistance systems (ADAS).

The steering ECU is connected to the motor driver. The motor driver is connected to the steering motor. The steering motor is incorporated in a steering mechanism including a steering wheel of the vehicle 12, a steering shaft connected to the steering wheel, a steering gear mechanism, and the like. The steering motor generates torque by electric power supplied from the motor driver, and this torque can be used to apply steering assist torque and to steer the left and right steered wheels. That is, the ECU 22 executes lane keeping control, which will be described later.

The display control device 20 is configured including a Central Processing Unit (CPU) 20A, a Read Only Memory (ROM) 20B, a Random Access Memory (RAM) 20C, an in-vehicle communication Interface (I/F) 20E, and an input/output I/F 20F. The CPU 20A, ROM 20B, RAM 20C, in-vehicle communication I/F 20E, and input/output I/F 20F are communicably connected to each other via an internal bus 20G. CPU 20A is an example of a processor.

The CPU 20A is a central processing unit that executes various programs and controls each section. That is, the CPU 20A reads a program from the ROM 20B and executes the program using the RAM 20C as a work area.

The ROM 20B stores various programs and various data. As shown in FIG. 2, the ROM 20B of this embodiment stores a processing program 100. Note that the processing program 100 may be stored in a storage such as a Hard Disk Drive (HDD) or Solid State Drive (SSD). The processing program 100 is a program for performing vehicle display control processing, which will be described later.

Returning to FIG. 1, RAM 20C temporarily stores programs or data as a work area.

The in-vehicle communication I/F 20E is an interface for connecting with the ECU 22. The interface uses a communication standard based on the Controller Area Network (CAN) protocol. The in-vehicle communication I/F 20E is connected to the ECU 22 via an external bus 20H.

The input/output I/F 20F is an interface for communicating with the input switch 31, monitor 32 and camera 36. Note that the camera 36 may be connected to the display control device 20 via an ECU 22 such as an ADAS-ECU.

The input switch 31 is configured as a touch panel that also serves as the monitor 32. Note that the input switch 31 may be a switch provided on an instrument panel, a center console, a steering wheel, or the like, for inputting an operation by a passenger's fingers. The input switch 31 in this case can employ, for example, a push-button numeric keypad, a touch pad, or the like.

A monitor 32 is a liquid crystal monitor provided on a meter panel, an instrument panel, or the like.

The camera 36 is a photographing device having an optical axis facing the traveling direction of the vehicle 12. The camera 36 may be installed inside the vehicle 12 or outside the vehicle 12. Note that the camera 36 may be connected to the ECU 22 as an ADAS-ECU.

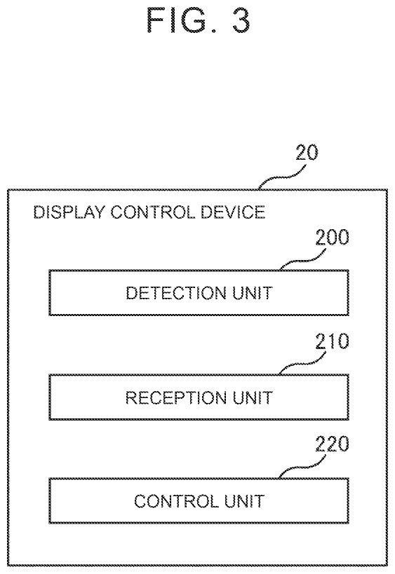

As shown in FIG. 3, in the display control device 20 according to this embodiment, the CPU 20A functions as a detection unit 200, a reception unit 210, and a control unit 220 by executing the processing program 100.

The detection unit 200 has a function of detecting lane markings in the target lane in which the vehicle 12 is traveling. In this embodiment, the detection unit 200 detects lane markings by using the difference in luminance in image data (hereinafter simply referred to as “image data”) of the scenery in front of the vehicle 12 captured by the camera 36. Since roads are generally paved with asphalt, the roads appear in the image data in a relatively low-brightness color (for example, black). On the other hand, since the lane markings are drawn on the road with higher brightness than the road, the lane markings appear in the image data in a color with relatively high brightness (for example, white or yellow).

Specifically, the detection unit 200 scans the entire image data of one frame in the horizontal direction at predetermined intervals. The detection unit 200 determines whether the contrast, which is the change in brightness, is greater than a predetermined threshold for each pixel. Then, the detection unit 200 extracts, from the one-frame image data, a pixel portion having a contrast greater than a predetermined threshold value as an edge point. Then, the detection unit 200 detects a partition line by connecting all the extracted edge points with a line.

Note that the method by which the detection unit 200 detects the marking line is not limited to the method described above. For example, the detection unit 200 may detect a partition line by extracting pixel portions whose brightness is equal to or higher than a predetermined threshold in the image data and connecting the pixel portions with lines.

Further, the detection unit 200 detects whether the vehicle 12 is before running. Specifically, when the speed of the vehicle 12 is 0 km, the detection unit 200 detects that the vehicle 12 is before running. The detection unit 200 detects that the vehicle 12 is not running when the speed of the vehicle 12 is not 0 km. Further, the detection unit 200 detects whether the driving of the vehicle 12 has ended. Specifically, the detection unit 200 detects whether the driving of the vehicle 12 has ended via a sensor that detects the rotation state of the ignition key.

The reception unit 210 has a function of receiving a display mode from an occupant of the vehicle 12 (hereinafter simply referred to as “occupant”). In this embodiment, the reception unit 210 receives the display mode from the occupant via the input switch 31 before the vehicle 12 runs. However, it is not limited to this example. For example, the reception unit 210 may receive a display mode from a passenger while the vehicle 12 is stopped. The reception unit 210 may receive the display mode via an information processing terminal such as a smartphone owned by the passenger. Further, the reception unit 210 may receive the display mode from the passenger while the vehicle 12 is running.

The reception unit 210 also has a function of receiving from the occupant any one of the adjacent display mode, center display mode, overall display mode, and vehicle exclusion display mode. The adjacent display mode is a mode in which the execution image E is displayed adjacent to the left lane marking image DL representing the left marking line of the target lane and the right lane marking image DR representing the right marking line of the target lane. The center display mode is a mode in which the execution image E is displayed at the center of the left lane marking image DL and the right lane marking image DR. The full display mode is a mode in which the execution image E is displayed entirely between the left lane marking image DL and the right lane marking image DR. In addition, the vehicle exclusion display mode is a mode in which the execution image E is displayed in the entire portion between the left lane marking image DL and the right lane marking image DR, excluding the vehicle image C representing the vehicle. Details of the execution image E will be described later.

That is, the reception unit 210 receives from the occupant one of the display modes for displaying the execution image E between the left lane marking image DL and the right lane marking image DR. Note that the display mode that the reception unit 210 receives from the occupants is not limited to one of the adjacent display mode, center display mode, overall display mode, and vehicle exclusion display mode. For example, the reception unit 210 may receive from the occupant any one of the display modes including the display mode in which the execution image E is displayed other than between the left lane marking image DL and the right lane marking image DR.

The control unit 220 has a function of displaying the execution image E on the monitor 32 in the display mode accepted by the reception unit 210. The execution image E is an image indicating whether or not lane keeping control is executed so that the vehicle 12 travels while maintaining the target lane. In this embodiment, the control unit 220 causes the monitor 32 to display the execution image E in the display mode accepted by the reception unit 210 when the lane keeping control is being executed. Control unit 220 does not display execution image E on monitor 32 when lane keeping control is not being executed. However, it is not limited to this example. For example, when the lane keeping control is being performed, the control unit 220 may cause the monitor 32 to display the execution image E in the display mode received by the reception unit 210, and when the lane keeping control is not being performed, the control unit 220 may cause the monitor 32 to display the execution image E in a display mode other than the received display mode. Further, the display of the execution image E by the control unit 220 is not limited to the monitor 32. For example, the control unit 220 may display the execution image E on the display unit of an information processing terminal such as a smartphone owned by the passenger.

In this embodiment, the control unit 220 has a function of displaying the execution image E without overlapping the marking line images representing the marking lines of the target lane (that is, the left lane marking image DL and the right lane marking image DR). Specifically, the control unit 220 displays the execution image E between the left lane marking image DL and the right lane marking image DR. This is because the reception unit 210 receives from the occupant any one display mode among a plurality of display modes for displaying the execution image E between the left lane marking image DL and the right lane marking image DR. However, it is not limited to this example. When the reception unit 210 receives a display mode in which the execution image E is displayed overlapping the marking line image, the control unit 220 may display the execution image E overlapping the marking line image. Further, when the reception unit 210 receives a display mode in which the execution image E is displayed in a position other than between the left lane marking image DL and the right lane marking image DR, the control unit 220 displays the left division line image DL and the right lane marking image DR. The execution image E may be displayed other than between DR.

In addition, the control unit 220 uses a known method (see, for example, Japanese Unexamined Patent Application Publication No. 2021-109582, Japanese Unexamined Patent Application Publication No. 2008-195402, Japanese Unexamined Patent Application Publication No. 2009-190464, Japanese Unexamined Patent Application Publication No. 2010-6279, and Japanese Patent No. 4349210)., the steering torque is applied to the steering mechanism to change the steering angle of the vehicle 12, thereby executing lane keeping control.

Note that, in the present embodiment, when the reception unit 210 receives a selection for executing lane keeping control via the input switch 31, the control unit 220 executes lane keeping control. On the other hand, when reception unit 210 receives a selection not to execute lane keeping control via input switch 31, control unit 220 does not execute lane keeping control. Flow of control

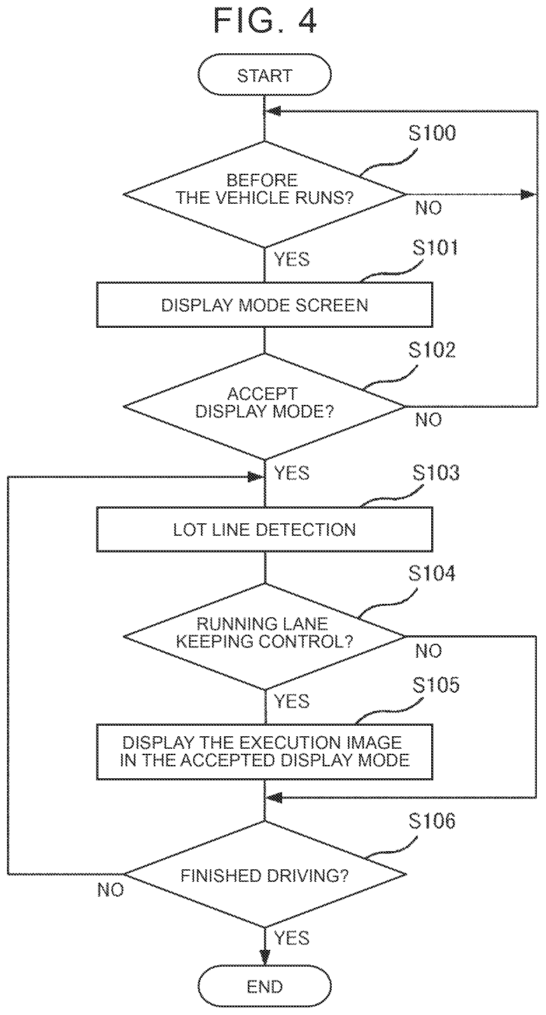

A flow of vehicle display control processing executed in the display control device 20 according to the present embodiment will be described with reference to FIG. 4. The vehicle display control process is implemented by the CPU 20A functioning as the detection unit 200, the reception unit 210, and the control unit 220.

In S100 of FIG. 4, the CPU 20A waits until the vehicle 12 is about to run. Specifically, the detection unit 200 determines whether the speed of the vehicle 12 is 0 km. When the vehicle 12 is before running (S100: YES), the CPU 20A proceeds to S101.

In S101, CPU 20A causes monitor 32 to display a display mode screen according to a predetermined format. Then, the process proceeds to S102.

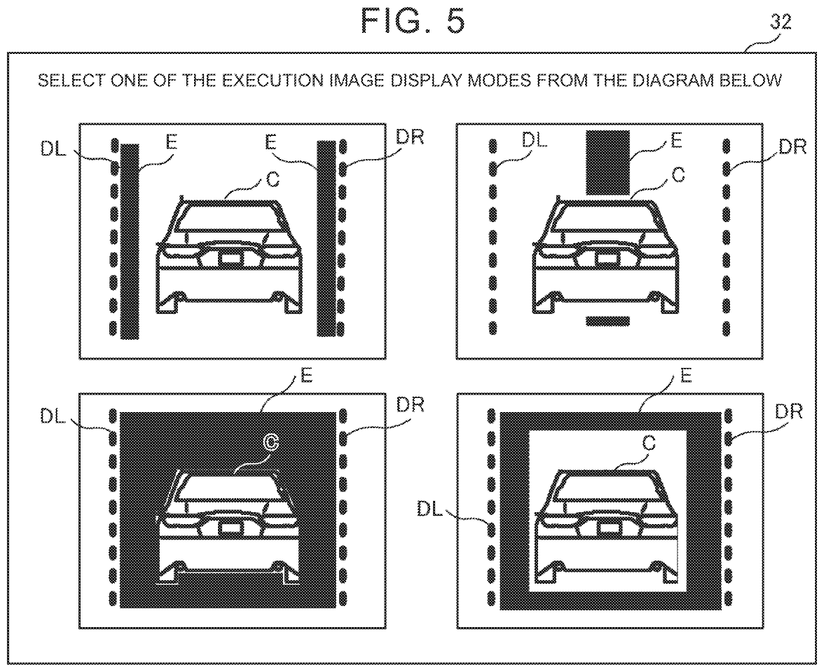

As shown in FIG. 5, the execution image E displayed in the adjacent display mode, center display mode, overall display mode, and vehicle exclusion display mode is displayed on the display mode screen. Also, on the display mode screen, a message prompting selection of any one display mode of the execution image from the adjacent display mode, center display mode, overall display mode, and vehicle exclusion display mode is displayed.

Specifically, in the example shown in FIG. 5, an execution image E and a vehicle image C are displayed on the upper left. The execution image E is adjacent to the left lane marking image DL and the right lane marking image DR. The vehicle image C is positioned at the center of the left lane marking image DL and the right lane marking image DR. Also, an execution image E and a vehicle image C are displayed on the upper right. The execution image E is positioned at the center of the left lane marking image DL and the right lane marking image DR, and is parallel to the left lane marking image DL and the right lane marking image DR. The vehicle image C is positioned at the center of the left lane marking image DL and the right lane marking image DR.

In the example shown in FIG. 5, an execution image E and a vehicle image C are displayed at the lower left. The execution image E is positioned entirely between the left lane marking image DL and the right lane marking image DR. The vehicle image C overlaps the execution image E. Also, an execution image E and a vehicle image C are displayed in the lower right. The execution image E is located in a portion excluding the vehicle image C from the entirety between the left lane marking image DL and the right lane marking image DR. The vehicle image C does not overlap the execution image E.

In S102, the CPU 20A determines whether or not the display mode of the execution image has been received from the display mode screen. When the CPU 20A receives the display mode of the execution image from the display mode screen (S102: YES), the process proceeds to S103. On the other hand, when the CPU 20A does not receive the display mode of the execution image from the display mode screen (S102: NO), the process returns to S100.

In S103, the CPU 20A detects lane markings in the target lane. Specifically, the CPU 20A detects the lane markings using the luminance difference in the image data.

In S104, the CPU 20A determines whether lane keeping control is being executed. When the lane keeping control is being executed (S104: YES), the CPU 20A proceeds to S105. On the other hand, when the lane keeping control is not being executed (S104: NO), the CPU 20A proceeds to S106.

At S105, the CPU 20A displays the execution image E in the display mode accepted at S102.

For example, when the CPU 20A accepts selection of the mode shown in the upper left of FIG. 5, the monitor 32 displays the execution image E and the vehicle image C. The execution image E is adjacent to the left lane marking image DL and the right lane marking image DR. The vehicle image C is positioned at the center of the left lane marking image DL and the right lane marking image DR. When the CPU 20A accepts the selection of the mode shown in the upper right of FIG. 5, the execution image E and the vehicle image C are displayed on the monitor 32. The execution image E is positioned at the center of the left lane marking image DL and the right lane marking image DR, and is parallel to the left lane marking image DL and the right lane marking image DR. The vehicle image C is positioned at the center of the left lane marking image DL and the right lane marking image DR.

Further, when the CPU 20A accepts selection of the mode shown in the lower left of FIG. 5, it causes the monitor 32 to display the execution image E and the vehicle image C. The execution image E is positioned entirely between the left lane marking image DL and the right lane marking image DR. The vehicle image C overlaps the execution image E. When the CPU 20A accepts the selection of the mode shown in the lower right of FIG. 5, the execution image E and the vehicle image C are displayed on the monitor 32. The execution image E is located in a portion excluding the vehicle image C from the entirety between the left lane marking image DL and the right lane marking image DR. The vehicle image C does not overlap the execution image E.

In S106, the CPU 20A determines whether the driving of the vehicle 12 has ended. Specifically, the CPU 20A determines whether the driving of the vehicle 12 has ended via a sensor that detects the rotation state of the ignition key. When the driving of the vehicle 12 ends (S106: YES), the CPU 20A ends the vehicle display control process. On the other hand, when the driving of the vehicle 12 has not ended (S106: NO), the CPU 20A returns to S103.

### Remarks

The display control device 20 according to the above embodiment was built in the vehicle 12. However, it is not limited to this example. For example, the display control device 20 may be installed outside the vehicle 12.

Note that the various processes executed by the CPU 20A by reading the software (program) in the above embodiment may be executed by various processors other than the CPU. In this case, the processor is a Programmable Logic Device (PLD) whose circuit configuration can be changed after manufacturing, such as a Field-Programmable Gate Array (FPGA), and an Application Specific Integrated Circuit (ASIC) for executing specific processing. A dedicated electric circuit or the like, which is a processor having a specially designed circuit configuration, is exemplified. Further, the processing described above may be executed by one of these various processors, or by a combination of two or more processors of the same or different type (for example, multiple FPGAs and a combination of CPU and FPGA, etc.). Further, a hardware configuration of the various processors is, more specifically, an electric circuit in which circuit elements such as semiconductor elements are combined.

Further, in the above embodiments, each program has been described as being pre-stored (installed) in a computer-readable non-temporary recording medium. For example, the processing program 100 in the display control device 20 is pre-stored in the ROM 20B. However, not limited to this, each program may be provided in any form recorded on non-temporary recording media such as Compact Disc Read Only Memory (CD-ROM), Digital Versatile Disc Read Only Memory (DVD-ROM), and Universal Serial Bus (USB) memory. Also, the program may be downloaded from an external device via a network.

The flow of processing described in the above embodiment is also an example. Unnecessary steps may be deleted, new steps added, or the order of processing may be changed without departing from the scope.

What is claimed is:

1. A vehicle display control device comprising:
a detection unit that detects a lane marking in a target lane on which a vehicle is traveling;
a reception unit that receives a display mode from an occupant of the vehicle; and
a control unit that causes a display unit to display, in the received display mode, an execution image indicating whether lane keeping control in which the vehicle travels staying in the target lane, is executed.

2. The vehicle display control device according to claim 1, wherein the control unit causes the execution image to be displayed without a lane marking image representing the lane marking of the target lane being overlapped.

3. The vehicle display control device according to claim 2, wherein the control unit causes the execution image to be displayed between a left lane marking image representing a left lane marking of the target lane and a right lane marking image representing a right lane marking of the target lane.

4. The vehicle display control device according to claim 3, wherein the reception unit receives, from the occupant, one display mode out of a mode in which the execution images are displayed adjacent to the left lane marking image and the right lane marking image, respectively, a mode in which the execution image is displayed in a middle of the left lane marking image and the right lane marking image, a mode in which the execution image is displayed in an entire area between the left lane marking image and the right lane marking image, and a mode in which the execution image is displayed in a portion excluding a vehicle image representing the vehicle from the entire area between the left lane marking image and the right lane marking image.

5. The vehicle display control device according to claim 1, wherein the reception unit receives the display mode from the occupant before the vehicle travels.
